(19) United States
(12) Patent Application Publication
(10) Pub. No.: US 2023/0309043 A1
(43) Pub. Date: Sep. 28, 2023

(54) METHODS AND SYSTEMS FOR HANDLING UE RADIO CAPABILITY (URC) INFORMATION

(71) Applicant: Samsung Electronics Co., Ltd., Suwon-si, Gyeonggi-do (KR)

(72) Inventors: Lalith KUMAR, Bangalore (IN); Kundan TIWARI, Bangalore (IN); Varini GUPTA, Bangalore (IN)

(21) Appl. No.: 18/012,851

(22) PCT Filed: Aug. 19, 2021
(86) PCT No.: PCT/KR2021/011029

§ 371 Date: Dec. 23, 2022

(30) Foreign Application Priority Data
Aug. 19, 2020 (IN) 202041035727
Aug. 12, 2021 (IN) 2020 41035727

(51) Int. Cl. H04W 60/04

(52) U.S. Cl. CPC H04W 60/04; H04W 84/042

(57) ABSTRACT

The disclosure relates to a communication method and system for converging a 5th-Generation (5G) communication system for supporting higher data rates beyond a 4th-Generation (4G) system with a technology for Internet of Things (IoT). The disclosure may be applied to intelligent services based on the 5G communication technology and the IoT-related technology, such as smart home, smart building, smart city, smart car, connected car, health care, digital education, smart retail, security and safety services. A method disclosed herein includes storing, by a network, URC identifiers (IDs) against all Public Land Mobile Network-Identifiers (IDs) belonging to a same Tracking Area Identity (TAI) list in a UE context information. The method further includes identifying, by a network, a mobility of the UE from a source PLMN ID to a target PLMN ID and indicating the URC ID of the target PLMN ID to a Radio Access Network (RAN) associated with the target PLMN based on the UE context information, if the source PLMN ID and the target PLMN ID belong to the same TAI list.

### TECHNICAL FIELD

The disclosure relates to the field of wireless networks and more particularly to handling UE Radio Capability (URC) information.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

### DISCLOSURE OF INVENTION

### Technical Problem

In general, a User Equipment (UE) receives a Tracking Area Identity (TAI) list from a network, when the UE triggers a registration procedure to register on one of Public Land Mobile Networks (PLMNs). The TAI list provides TAIs of a plurality of PLMNs/PLMN identifiers (PLMN IDs) present in a registration area of the UE. The UE triggers the registration procedure on one of the PLMN IDs to get synchronized with a UE Radio Capability (URC) ID on the corresponding PLMN ID. However, in conventional versions of the 3GPP specification, the UE triggers the registration procedure each time when the UE moves from one PLMN ID to another PLMN ID, even though the PLMN IDs belong to the same TAI list. Thus, resulting in an unnecessary signaling load on the network.

### Solution to Problem

Accordingly, the embodiments herein disclose methods and systems for handling User Equipment (UE) Radio Capability (URC) information for a UE. A method disclosed herein includes determining, by a network, mobility of the UE from a first Public Land Mobile Network (PLMN) to a second PLMN. The method includes determining, by the network, if the first PLMN and the second PLMN belong to a same Tracking Area Identity (TAI) list. The method includes indicating, by the network, a URC identifier (URC-ID) of the second PLMN to a Radio Access Network (RAN) associated with the second PLMN based on UE context information, if the first PLMN and the second PLMN belong to the same TAI list.

Accordingly, the embodiments herein disclose a network for handling User Equipment (UE) Radio Capability (URC) information for a UE. The network is configured to determine mobility of the UE from a first Public Land Mobile Network (PLMN) to a second PLMN. The network is configured to determine if the first PLMN and the second PLMN belong to a same Tracking Area Identity (TAI) list. The network is configured to indicate a URC identifier (URC-ID) of the second PLMN to a Radio Access Network (RAN) associated with the second PLMN based on UE context information, if the first PLMN and the second PLMN belong to the same TAI list.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### Advantageous Effects of Invention

The principal object of the embodiments herein is to disclose methods and systems for handling UE Radio Capability (URC) information.

Another object of the embodiments herein is to disclose methods and systems for storing URC identifiers (IDs) against all Public Land Mobile Network-Identifiers (IDs) belonging to a same Tracking Area Identity (TAI) list in a UE context information.

Another object of the embodiments herein is to disclose methods and systems for identifying a mobility of the UE from a source PLMN ID to a target PLMN ID and indicating the URC ID of the target PLMN ID to a Radio Access Network (RAN) associated with the target PLMN based on the UE context information, if the source PLMN ID and the target PLMN ID belong to the same TAI list.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1a illustrates an example scenario, wherein a User Equipment (UE) triggers unnecessary registration procedures that result in signaling load on a network;

FIG. 1B illustrates an example scenario, wherein the UE and a network are out of sync with respect to an allowed Closed Access Group (CAG) list;

FIG. 2a illustrates a wireless communication system, according to embodiments as disclosed herein;

FIG. 2b illustrates a wireless communication system, according to embodiments as disclosed herein;

FIG. 3 is a block diagram depicting various components of a network/Core Network (CN) for handling User Equipment (UE) Radio Capability (URC) information for a UE, according to embodiments as disclosed herein;

FIG. 4 is an example block diagram depicting various components of the UE for receiving the URC information, according to embodiments as disclosed herein;

FIG. 5 is a sequence diagram depicting handling of the URC information for the UE, according to embodiments as disclosed herein; and

FIG. 6 illustrates a method for handling recovery of the UE in a 5G network, wherein the UE and the network are out of synchronization with respect to an allowed Closed Access Group (CAG) list, according to embodiments as disclosed herein.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### MODE FOR THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

Embodiments herein disclose methods and systems for handling UE Radio Capability (URC) information for a User Equipment (UE).

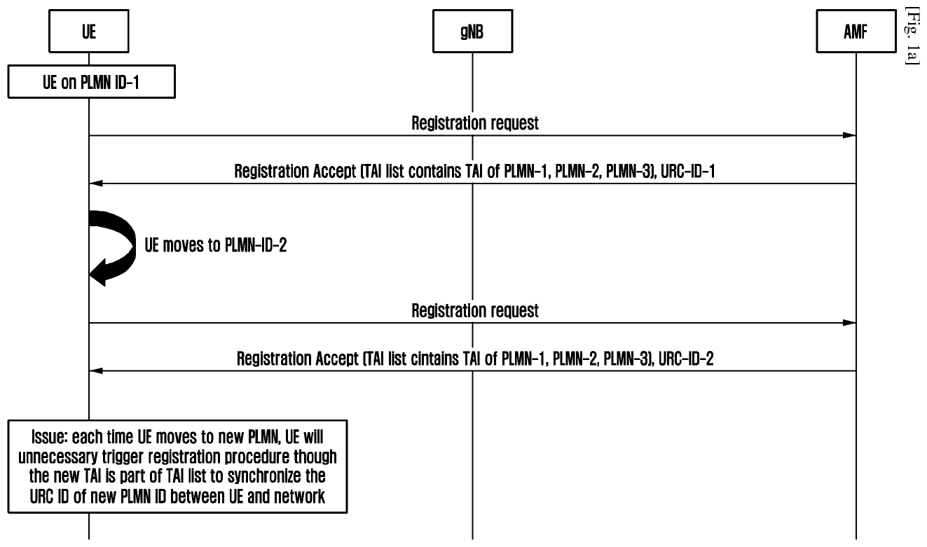

Referring now to the drawings, and more particularly to FIGS. 1a through 6, where similar reference characters denote corresponding features consistently throughout the figures, there are shown example embodiments.

In general, a User Equipment (UE) receives a Tracking Area Identity (TAI) list from a network, when the UE triggers a registration procedure to register on one of Public Land Mobile Networks (PLMNs). The TAI list provides TAIs of a plurality of PLMNs/PLMN identifiers (PLMN IDs) present in a registration area of the UE. The UE triggers the registration procedure on one of the PLMN IDs to get synchronized with a UE Radio Capability (URC) ID on the corresponding PLMN ID. However, in conventional versions of the 3GPP specification, the UE triggers the registration procedure each time when the UE moves from one PLMN ID to another PLMN ID, even though the PLMN IDs belong to the same TAI list. Thus, resulting in an unnecessary signaling load on the network.

FIG. 1a illustrates an example scenario, wherein the UE triggers unnecessary registration procedures that result in the signaling load on the network.

As depicted in FIG. 1a, the UE triggers the registration procedure by sending a registration request to an Access and Mobility Management Function (AMF) of the network through a gNodeB (gNB) associated with the PLMN ID-1. The UE receives a registration accept from the AMF, wherein the registration accept includes the TAI list and a URC ID-1 of the PLMN ID-1. The TAI list indicates TAIs of the PLMN ID-1, a PLMN ID-2, and a PLMN ID-3.

The UE moves from the PLMN ID-1 to the PLMN ID-2. On moving from the PLMN ID-1 to the PLMN ID-2, the UE triggers the registration procedure by sending the registration request to the AMF of the PLMN ID-2. In such a scenario, the AMF deletes the URC ID-1 of the PLMN ID-1 and assigns a URC ID-2 for the PLMN ID-2. The AMF sends the registration accept to the UE, wherein the registration accept includes the TAI list and the URC ID-2 of the PLMN ID-2. Thus, the UE triggers the unnecessary registration procedure each time when the UE moves from one PLMN ID to another PLMN ID, which creates the signaling load on the network though both the PLMN IDs are part of the same registration area (i.e., the TAI list). In addition, on triggering the registration procedure each time, the AMF deletes the URC ID of the source PLMN ID (for example, the PLMN ID-1) and creates the signaling to assign the URC ID for the target PLMN ID (for example, the PLMN ID-2) within the core network for example, between the AMF and a UE radio Capability Management Function (UCMF) and between the network and Radio Access Network (RAN) node.

Further, the UE receives an allowed Closed Access Group (CAG) list, where the CAG list includes a set of CAG cells where the UE is allowed to have mobility and obtain services from the network. There are situations where the UE and the network may go out of synchronization with respect to the allowed CAG list. For example, the UE and the network may go out of synchronization when the network is not able to update the allowed CAG list to the UE since the UE is not in a service, or the like. Due to which it is possible that the UE may end up camping on a CAG cell which is not part of the allowed CAG list of the UE.

FIG. 1B illustrates an example scenario, wherein the wherein the UE and the network are out of sync with respect to an allowed CAG list. The UE initiates a resume procedure from a CAG ID-1. The CAG-ID-1 is not in the allowed CAG list which is available with the gNB. The gNB provides a resume reject or an RRC Connection release to the UE. The UE may be stuck on the CAG ID-1 as the UE does not know the reason for receiving the resume reject from the gNB. Whenever a paging has to be executed for the UE, the paging may be executed in the allowed CAG list which is available with the network. However, the UE camping on the CAG cell which is not part of the allowed CAG list (from the network perspective) may not receive a paging message.

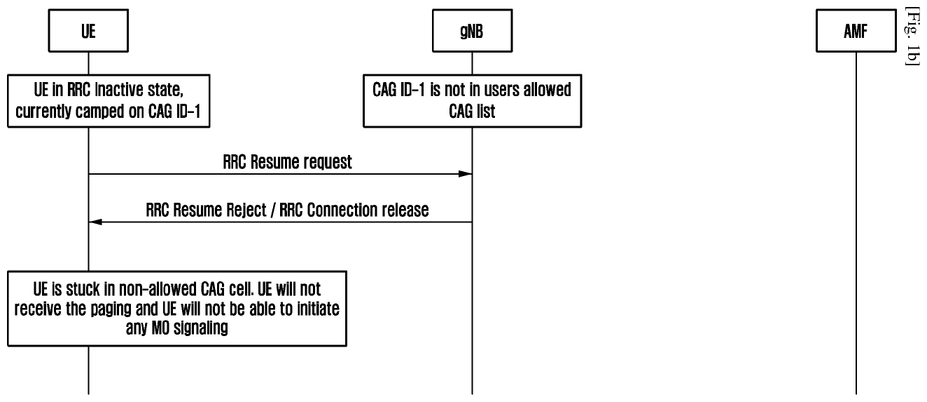

FIGS. 2a and 2b illustrate a wireless communication system 200, according to embodiments as disclosed herein. The wireless communication system 200 referred herein may be configured to signal/indicate User Equipment (UE) Radio Capability (URC) information of Public Land Mobile Network (PLMN) to a UE using Radio Capability Signalling Optimization (RACS) method. The RACS optimizes the signaling of the URC information of the PLMN to the UE by improving network throughput, efficiency, and so on.

The RACS assigns an identifier (ID) to represent a set of UE radio capabilities (URC). The ID may be referred as a UE Radio Capability ID (URC ID). In an example, the URC ID may be UE manufacturer-assigned ID. In another example, the URC ID may be a PLMN assigned ID. The URC ID may be an alternative to the signalling of the URC information over a radio interface within a New Generation (NG)-Radio Access Node (RAN), or from the NG-RAN to an Evolved-UMTS Terrestrial Radio Access Network (E-UTRAN), or from an Access and Mobility Management Function (AMF) to the NG-RAN, or between Core Network (CN) nodes supporting the RACS, or the like.

The URC ID of the PLMN Includes information like the ID, which uniquely identifies resources such as, but are not limited to, frequency bands, radio bearers, power class, carrier aggregation (CA) band combinations, and so on, supported by the UE on the corresponding PLMN. In other words, the URC ID identifies the URC information. Embodiments herein use the terms such as “URC ID”, “URC information”, “Radio Capability ID”, and so on, interchangeably through the document.

The wireless communication system 200 includes one or more UEs 202, one or more Radio Access Networks (RANs) 204a-204n, and one or more networks/Core Networks (CNs) 206a-206n.

The UE(s) 202 referred herein may be a user device that is capable of registering with one or more PLMNs for receiving communication services. The PLMN(s) referred herein may be a home network or a visited network with which the UE 202 registers for the communication services. The PLMN may be identified using a PLMN identifier (ID). The PLMN ID includes a Mobile County Code (MCC) and a Mobile Network Code (MNC). Embodiments herein use the terms “PLMN”, “PLMN ID”, “PLMN cell”, “PLMN ID cell”, and so on, interchangeably to a network cell offered by a specific operator in a specific region to provide the communication services.

Examples of the UE 202 may be, but are not limited to, a mobile phone, a smartphone, a tablet, a phablet, a personal digital assistant (PDA), a laptop, a computer, a wearable computing device, a vehicle infotainment device, an Internet of Things (IoT) device, a Virtual Reality (VR) device, a Wireless Fidelity (Wi-Fi) router, a robot, an auto-guided vehicle, or any other device that capable of registering with the one or more PLMNs. Examples of the communication services may be, but are not limited to, voice-based services, data-based services, and so on. Examples of the data-based services may be, but not limited to, surfing the Internet, chat sessions, map-based services, Voice over Internet Protocol (IP) (VoIP), and so on. The UE 202 may comprise of one or more processors/Central Processing Units (CPUs), a memory, a storage, a transceiver, and so on, for performing at least one intended function/operation.

The UE 202 may be configured to receive a Tracking Area Identity (TAI) list from one of the networks (for example, 206a) associated with a current location of the UE 202. The TAI list indicates one or more Tracking Area Identities (TAIs) of the one or more PLMN IDs/PLMNs, where the network 206a determines that the UE 202 is located. The TAI list depicts the one or more PLMNs present in a registered tracking area (TA)/registration area for the UE 202. The UE 202 may register with the one or more PLMN IDs and receive the TAI list with a plurality of PLMN IDs, so that the UE 202 may roam around within the TAI list of multiple PLMN IDs without a need to perform Tracking Area Update (TAU). The TAU may also be referred as a registration procedure for mobility and periodic registration update.

The UE 202 may register with the one of the PLMNs for the communication services, by performing a registration procedure with the one of the networks 206a-206n. In an example, the UE 202 may register with the PLMN, when the UE 202 switches ON in the area/location of the corresponding PLMN. In another example, the UE 202 may register with the PLMN, when the UE 202 switches to the corresponding PLMN from another PLMN by performing a handover (HO). In another example, the UE 202 may register with the PLMN, when the UE 202 re-selects to the corresponding PLMN. In another example, the UE 202 may register with the PLMN, due to an idle mode mobility. The idle mode mobility involves moving of the UE 202 to a new PLMN, while the UE 202 is not involved in an active communication with the serving PLMN.

The RAN(s) 204a-204n and the network(s)/CNs 206a-206n may support various Radio Access Technologies (RATs). Examples of the RATs may be, but are not limited to, a 3GPP 3rd Generation (3G), Long Term Evolution (LTE/4G), LTE-Advanced (LTE-A), Fifth Generation (5G) New Radio, a Universal Mobile Telecommunications Service (UMTS), a Global System for Mobile Communications (GSM) Enhanced Data rates for GSM Evolution (EDGE) Radio Access Network (GERAN) system Wireless Local Area Network (WLAN), Worldwide Interoperability for Microwave Access (WiMAX/IEEE 802.16), Wi-Fi (IEEE 802.11), Evolved-UTRA (E-UTRA), or any other next generation networks.

The RAN (204a-204n) and the network/CN (206a-206n) may be associated with the one or more PLMNs. For example, as depicted in FIG. 2a, the RAN 204a and the network 206a may be associated with the PLMNs/PLMN IDs 1-n present in a tracking area 1 (TA 1). The RAN (204a-204n) and the CN (206a-206n) may comprise of one or more processors/Central Processing Units (CPUs), a memory, a storage, a transceiver, and so on, for performing at least one intended function/operation.

The RAN (204a-204n) may comprise of nodes/Base Stations (BSs) such as, but are not limited to, evolved nodes (eNBs), New Radio nodes (gNBs), and so on. The RAN (204a-204n) may communicate with the UE(s) 202 and the CN (206a-206n) over an interface (for example: a radio interface or a non-radio interface) supported by the associated RAT. The RAN (204a-204n) may be configured to connect the UE(s) 202 to the associated CN (206a-206n). The RAN (204a-204n) may be configured to perform radio resource management functions such as, but not limited to, radio bearer control, radio admission control, connection mobility control, dynamic allocation of resources to the UE 202 in an uplink/downlink (scheduling), and so on.

The CN (206a-206n) may comprise one of, but is not limited to, an Evolved Packet Core (EPC), a 5G core (5GC) network, and so on. The CN (206a-206n) may be connected to the RAN (204a-204n) and an external data network (not shown) over the interface supported by the associated RAT. Examples of the external data network may be, but are not limited to, the Internet, a Packet Data Network (PDN), an Internet Protocol (IP) Multimedia Core Network Subsystem, and so on.

Embodiments herein use the terms “BS”, “RAN”, “cell”, and so on, interchangeably to refer to a Base Transceiver System (BTS)/station that communicates with the one or more UEs 202.

Embodiments herein use the terms “network”, “CN”, and so on, interchangeably to refer to a core network node.

In an embodiment, the CNs 206a-206n may be configured to handle the URC information for the associated UEs 202.

The CN (for example: the CN 206a associated with a TA-1/TAI list-1) receives a registration request from the UE 202 through the associated RAN 204a to register with a first/source PLMN (PLMN ID 1) of the plurality of PLMNs present in the TAI list-1. The CN 206a sends a registration accept message to the UE 202 in response to the received registration request through the associated RAN 204a. The registration accept message includes the TAI list and a URC ID of the first PLMN to the UE. The TAI list indicates the TAIs of the plurality of PLMNs (including the first PLMN) present in the registered tracking area for the UE 202. In an example, the CN 206a provides the TAI list-1 which includes the TAIs of the plurality of PLMNs present in the TA 1 to the UE 202. The CN 206a stores the URC ID of the first PLMN in a UE context information. The UE context information includes the URC IDs with respect to the plurality of PLMNs of the same TAI list/TA.

The CN 206a determines a mobility of the UE 202 from the first PLMN to a second/target PLMN, when the UE 202 enters a connected mode on the second PLMN due to a Non-Access Stratum (NAS) procedure and triggers a service request (SR) procedure on the second PLMN.

The CN 206a checks if the second PLMN belongs to the same TAI list of the first PLMN (i.e., the TAI list that includes the first PLMN or the TAI list handled by the CN 206a). If the second PLMN belongs to the same TAI list of the first PLMN (as depicted in FIG. 2a), the CN 206a determines if the URC ID of the second PLMN is present in the UE context information.

If the URC ID of the second PLMN is present in the UE context information, the CN 206a indicates the URC ID of the second PLMN to the RAN 204a associated with the second PLMN.

If the URC ID of the second PLMN is not present in the UE context information, the CN 206a assigns the URC ID for the second PLMN using the standard defined technique of assigning the URC ID to the UE 202 with the help of a UE Capability Management Function (UCMF). The CN 206a stores the URC ID for the second PLMN. The CN 206a indicates the URC ID of the second PLMN to the RAN 204a associated with the second PLMN and the UE 202. In an example, the CN 206a indicates the URC ID of the second PLMN to the UE 202 in a Non-Access Stratum (NAS) message. In another example, the CN 206a indicates the URC ID of the second PLMN to the UE 202 in a UE configuration update (UCU) procedure. In an embodiment, the CN 206a and the RAN 204a use at most one URC-ID from the UE context information at any given time. The URC-ID may be the URC-ID associated with the PLMN selected by the UE 202.

Thus, when the UE 202 moves from the first/source PLMN to the second/new/target PLMN belonging to the same TAI list/registration area, the UE 202, and the CN 206a initiates using the respective assigned URC ID of the respective new PLMN, if available in the UE context information implicitly without peer-to-peer signalling.

In an embodiment, the UE 202, and the RAN 204a may receive the URC IDs of the plurality of PLMNs (belonging to the same TAI list) from the CN 206a in the registration accept message. In an embodiment, the UE 202 may receive the URC ID of the currently selected PLMN in the registration accept message and followed with the UCU procedure to receive rest of the URC IDs of other PLMN IDs, whose TAIs are part of the TAI list.

If the second PLMN does not belong to the same TAI list of the first PLMN (i.e., the second PLMN belongs to the new TAI list, which is not part of the TAI list handled by the CN 206a) as depicted in FIG. 2b, the CN 206a provides the active URC ID to the CN (206b-206n) associated with the new TAI list. The active URC ID may be the URC ID of the PLMN on which the UE 202 was camping when a HO or a reselection to the new TAI is triggered. Alternatively, the CN 206a provides a mapping of all the URC IDs with respect to all the PLMNs to the CN 206a associated with the new TAI list.

FIGS. 2a and 2b show exemplary blocks of the wireless communication system 200, but it is to be understood that other embodiments are not limited thereon. In other embodiments, the wireless communication system 200 may include less or more number of blocks. Further, the labels or names of the blocks are used only for illustrative purpose and does not limit the scope of the embodiments herein. One or more blocks can be combined together to perform same or substantially similar function in the wireless communication system 200.

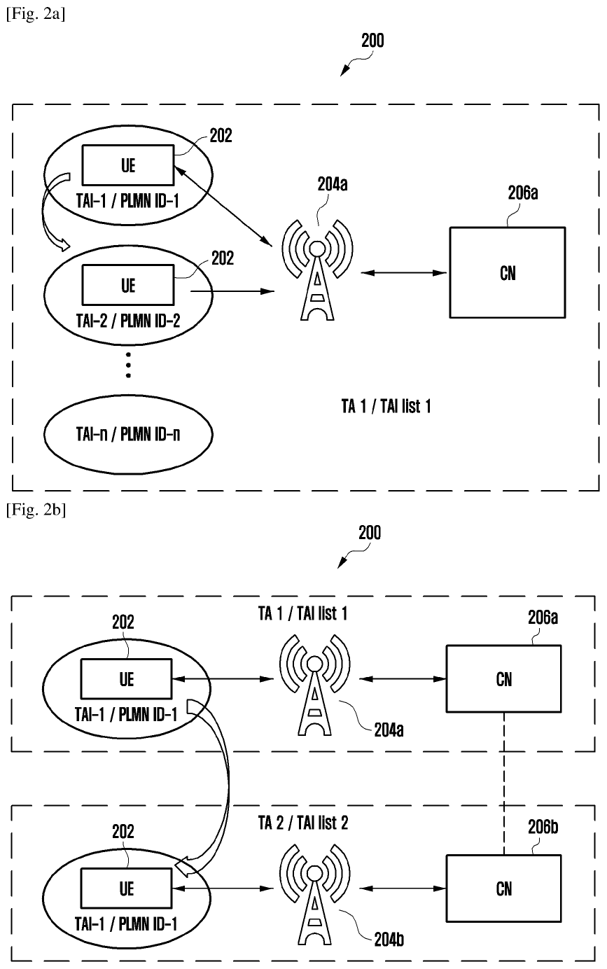

FIG. 3 is a block diagram depicting various components of the CN (for example: 206a) for handling the URC information for the UE 202, according to embodiments as disclosed herein. The CN 206a may include at least one of, but is not limited to, an EPC, a 5GC network, and so on. The CN 206a includes a memory 302, an interface 304, and a network entity 306.

The memory 302 may store information such as, but are not limited to, the UE context information, the TAI list, and so on. Examples of the memory 302 may be, but are not limited to, NAND, embedded Multimedia Card (eMMC), Secure Digital (SD) cards, Universal Serial Bus (USB), Serial Advanced Technology Attachment (SATA), solid-state drive (SSD), and so on. The memory 302 may also include one or more computer-readable storage media. The memory 302 may also include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 302 may, in some examples, be considered a non-transitory storage medium. The term “non-transitory” may indicate that the storage medium is not embodied in a carrier wave or a propagated signal. However, the term “non-transitory” should not be interpreted to mean that the memory 302 is non-movable. In some examples, the memory 302 can be configured to store larger amounts of information than the memory. In certain examples, a non-transitory storage medium may store data that can, over time, change (e.g., in Random Access Memory (RAM) or cache).

The interface 304 may be configured to enable the CN 206a to communicate with at least one of, the UE(s) 202, the RANs 204a, the other CNs 206b-206n, and so on, over the interface supported by the corresponding RAT. Examples of the interface may be at least one of a wired or wireless fronthaul interface, a wired/non-radio or wireless/radio interface, or any structure supporting communications over a wired or wireless connection.

The network entity 306 may be a core functional element/module that depends on the RAT supported by the CN 206a. In an example, if the CN 206a supports an LTE/4G network, the network entity 306 may be a Mobility Management Entity (MME). In another example, if the CN 206a supports a 5G network, the network entity 306 may be an Access and Mobility Management Function (AMF).

The network entity 306 may be configured to create the URC ID for the PLMN, on receiving the registration request from the UE 202 to register with the PLMN. The network entity 306 stores the URC ID in the UE context information with respect to the PLMN. Thus, the UE context information includes the URC IDs against all the PLMNs belonging to the same TAI list.

The network entity 306 may also be configured to handle the URC information for the UE 202 based on the UE context information. The network entity 306 determines the mobility of the UE 202 from the first PLMN to the second PLMN, when the UE 202 enters the connected mode on the second PLMN due to the NAS procedure.

On determining the mobility of the UE 202 from the first PLMN to the second PLMN, the network entity 306 determines if the first PLMN and the second PLMN belong to the same TAI list.

If the first PLMN and the second PLMN belong to the same TAI list, the UE 202 indicates the URC ID of the second PLMN to the RAN (for example: the RAN 204a) associated with the second PLMN based on the UE context information. For indicating the URC ID of the second PLMN to the RAN 204a, the network entity 306 determines if the URC ID of the second PLMN is stored in the UE context information. If the URC ID of the second PLMN is stored in the UE context information, the network entity 306 indicates the URC ID of the second PLMN to the RAN 204a associated with the second PLMN. If the URC ID of the second PLMN is not stored in the UE context information, the network entity 306 assigns the URC ID for the second PLMN. The network entity 306 stores the assigned URC ID of the second PLMN in the UE context information. The network entity 306 indicates the URC ID of the second PLMN to the UE 202 and the RAN 204a associated with the second PLMN. In an example, the network entity 306 indicates the URC ID of the second PLMN to the UE 202 using the NAS message or the UCU procedure. Alternatively, the network entity 306 indicates the URC IDs of the plurality of PLMNs of the same TAI list to the RAN 204a and the UE 202 in the registration accept message.

If the first PLMN and the second PLMN do not belong to the same TAI list, the network entity 306 provides the active URC ID of the PLMN to the CN (for example, 206b-206n) associated with the second PLMN belonging to the new TAI list, wherein the active URC ID may be the URC ID on which the UE 202 was camping when the HO or the reselection to the new TAI is triggered. Alternatively, the network entity 306 provides the mapping of all the URC IDs respect to all the PLMNs to the CN (206b-206n) associated with the second PLMN of the new TAI list.

FIG. 3 show exemplary blocks of the CN 206a, but it is to be understood that other embodiments are not limited thereon. In other embodiments, the CN 206a may include less or more number of blocks. Further, the labels or names of the blocks are used only for illustrative purpose and does not limit the scope of the embodiments herein. One or more blocks can be combined together to perform same or substantially similar function in the CN 206a.

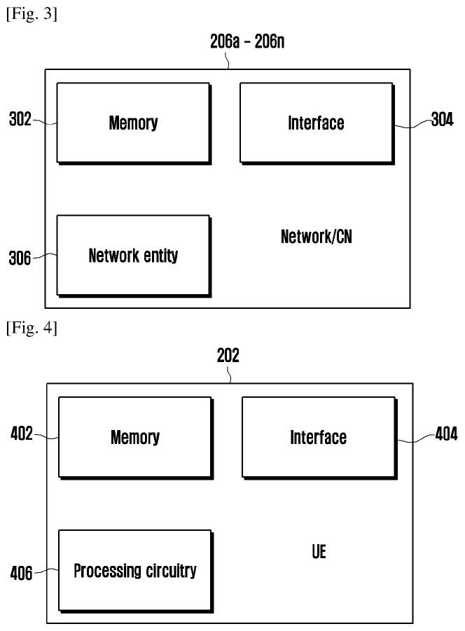

FIG. 4 is an example block diagram depicting various components of the UE 202 for receiving the URC information, according to embodiments as disclosed herein. The UE 202 includes a memory 402, an interface 404, and a processing circuitry 406. The UE 202 may also include at least one of, at least one antenna, at least one RF transceiver, a transmission processing circuitry, a reception processing circuitry, and so on (not shown).

The memory 402 stores at least one of, the TAI list, the URC IDs of the PLMNs, and so on. Examples of the memory 402 may be, but are not limited to, NAND, embedded Multimedia Card (eMMC), Secure Digital (SD) cards, Universal Serial Bus (USB), Serial Advanced Technology Attachment (SATA), solid-state drive (SSD), and so on. The memory 402 may also include one or more computer-readable storage media. The memory 402 may also include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 402 may, in some examples, be considered a non-transitory storage medium. The term “non-transitory” may indicate that the storage medium is not embodied in a carrier wave or a propagated signal. However, the term “non-transitory” should not be interpreted to mean that the memory 402 is non-movable. In some examples, the memory 402 can be configured to store larger amounts of information than the memory. In certain examples, a non-transitory storage medium may store data that can, over time, change (e.g., in Random Access Memory (RAM) or cache).

The interface 404 may be configured to enable the UE 202 to communicate with the associated RAN (204a-204n) through an interface. Examples of the interface may be, but are not limited to, a wired or wireless fronthaul interface, a wired or wireless backhaul interface, or any other structure supporting communications over a wired or wireless connection.

The processing circuitry 406 includes at least one of, a single processer, a plurality of processors, multiple homogeneous or heterogeneous cores, multiple Central Processing Units (CPUs) of different kinds, microcontrollers, special media, and other accelerators.

The processing circuitry 406 sends the registration request to the CN (for example, 206a) via the associated RAN (for example, 204a) to register with one of the PLMNs (for example herein: the first PLMN (for example, a TAI 1/PLMN ID 1 of the TAI list 1). In response to the sent registration request, the processing circuitry 406 receives the registration accept message from the CN 206a via the RAN 204a. The registration accept message includes the TAI list and the URC ID of the first PLMN. The TAI list includes the TAIs of the PLMNs belonging to the same TA/registration area.

The processing circuitry 406 triggers the NAS procedure like the SR procedure, when the UE 202 wants to enter the connected mode on the second PLMN (for example, a TAI 2/PLMN ID 2). In response to the triggered SR procedure, the processing circuitry 406 receives the TAI list and the URC ID of the second PLMN from the CN 206a via the RAN 204a, if the first PLMN and the second PLMN belong to the same TAI list and the URC ID of the second PLMN is not stored in the UE context information at the CN 206a. Alternatively, in response to the triggered service request procedure by the processing circuitry 406, the CN 206a sends the URC ID of the second PLMN to the RAN 204a associated with the second PLMN and does not send the URC ID of the second PLMN to the UE, if the first PLMN and the second PLMN belong to the same TAI list and the URC ID of the second PLMN is stored in the UE context information at the CN 206a.

The processing circuitry 406 may also be configured to receive from the CN 206a, the URC ID of the currently selected PLMN in the registration accept message and followed with the UCU procedure to receive rest of the URC IDs of other PLMN IDs, whose TAIs are part of the TAI list.

FIG. 4 show exemplary blocks of the UE 202, but it is to be understood that other embodiments are not limited thereon. In other embodiments, the UE 202 may include less or more number of blocks. Further, the labels or names of the blocks are used only for illustrative purpose and does not limit the scope of the embodiments herein. One or more blocks can be combined together to perform same or substantially similar function in the UE 202.

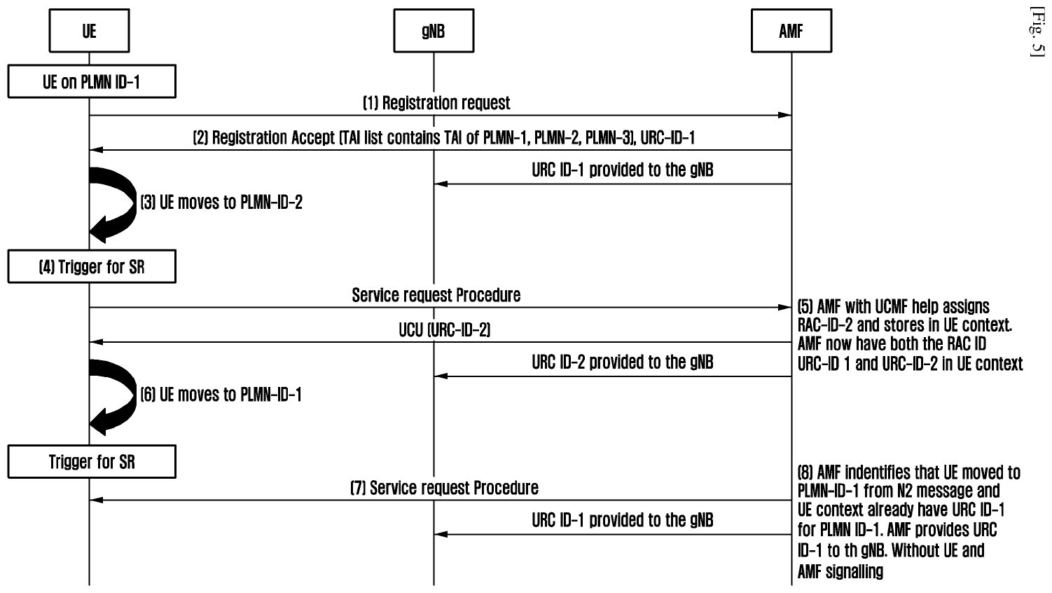

FIG. 5 is a sequence diagram depicting handling of the URC information for the UE 202, according to embodiments as disclosed herein. Embodiments herein explain the handling of the URC information for the UE 202, by considering the CN 206a and the RAN 204a supporting a 5G/NR network as an example, but it may be obvious to a person skilled in the art that any other RAT may be considered.

In an embodiment, the network element/AMF 306 of the CN 206a stores the URC-ID for each PLMN ID. The UE 202 and the AMF 306 implicitly use the stored URC ID without peer to peer signaling when the UE moves between the PLMN IDs.

As depicted in FIG. 5, in step 1, the UE 202 triggers the registration procedure on the PLMN ID-1. In step 2, the UE 202 receives registration accept with the TAI list containing the TAIs of the three PLMN IDs, a PLMN ID-1/TAI-1, a PLMN ID2/TAI-2, a PLMN ID-3/TAI-3, and a URC ID-1. The URC ID-1 is applicable to the PLMN ID-1. The AMF 306 stores the URC-ID-1 in the UE context information with respect to the PLMN ID-1.

In step 3, the UE 202 moves to the PLMN ID-2 from the PLMN ID-1. In step 4, the UE 202 triggers the SR procedure, when the trigger for the SR is met. In step 5, the AMF 306 identifies that the UE 202 is moved to the PLMN ID-2 for example with the help of an N2 message or a RAN message. In an example herein, the AMF 306 determines that the URC ID for PLMN ID-2 is not available in the UE context information. In such a scenario, the AMF 306 assigns the URC ID-2 for the PLMN ID-2 by following the standard URC ID assignment procedure in interaction with the UCMF and provides the URC ID-2 of the PLMN ID-2 to the UE 202 in the NAS message like the UE configuration update (UCU) procedure and to the RAN/gNB 204a. The AMF 306 stores both the URC ID-1 and the URC ID-2 in the UE context information with respect to the PLMN ID-1 and the PLMN ID-2, respectively. Similarly, the AMF 306 stores URC ID-1, URC ID-2, . . . URC ID-n with respect to the PLMN ID-1, PLMN ID-2 . . . . PLMN ID-n in the UE context information maintained at the AMF 306.

In step 6, the UE 202 moves to the PLMN ID-1. In step 7, the UE 202 triggers the SR procedure, when the trigger for the SR is met. In step 8, the AMF 306 identifies that the UE 202 is moved to the PLMN ID-1 for example with the help of the N2 message or the RAN message. The AMF determines that the URC-ID (i.e., URC-ID-1) for the PLMN ID-1 is already available in the UE context information. In such a scenario, the AMF 306 starts using the URC ID-1 of PLMN ID-1 and provides the URC ID-1 of the PLMN ID-1 to the RAN/gNB 204a associated with the PLMN ID-1.

Thus, when the UE 202 moves to the new PLMN ID within the registration area, the UE 202 and the AMF 306 start using the respective assigned URC ID of the respective new PLMN ID, if available in the UE context implicitly without peer-to-peer signalling.

Further, when the UE 202 moves to the PLMN of the new TAI list, the AMF 306 provides the active URC ID to the target CN (for example, 206b-206n) associated with the new TAI list (i.e., the URC ID of the PLMN on which the UE was camping when the HO or reselection is triggered). Also, the AMF 306 may provide the mapping of all the URC IDs with respect to all the PLMN IDs to the target CN associated with the new TAI list.

In an embodiment herein, the AMF 306 may indicate the registration accept message including the multiple PLMN IDs and respective associated URC ID to the UE 202 and the gNB 204a.

In an embodiment herein, the UE 202 receives the URC ID of the current selected PLMN in the registration accept message and followed with the UCU procedure to receive rest of the URC IDs of other PLMN IDs, whose TAIs are part of the TAI list. The AMF 306 also stores all the URC IDs marked as equivalent to each other in the UE context information.

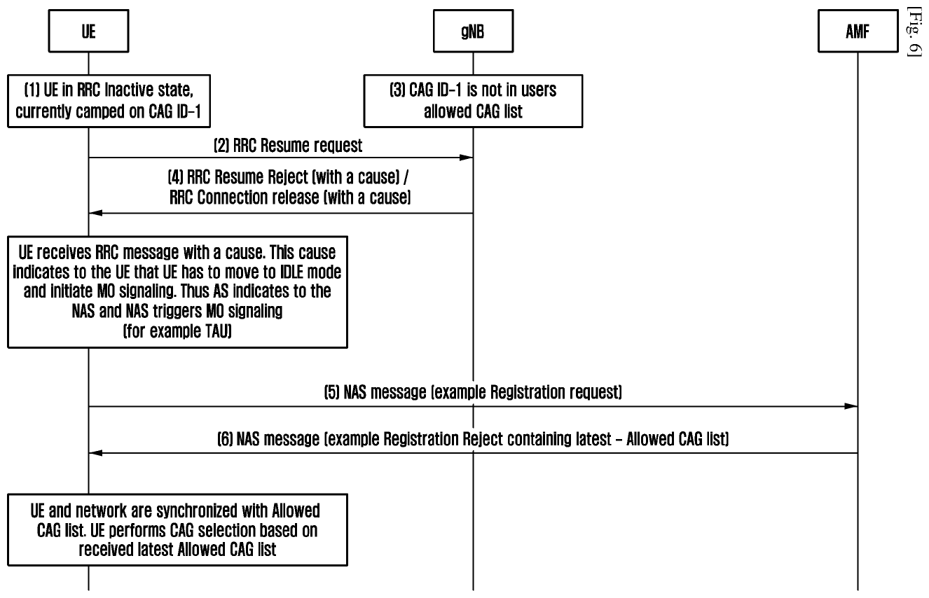

FIG. 6 depicts a method for handling recovery of the UE 202 in a 5G network, wherein the UE and the network are out of synchronization with respect to an allowed Closed Access Group (CAG) list, according to embodiments as disclosed herein. In step 1, the UE 202 is in a Radio Resource Control (RRC) Inactive state. In step 2, the UE 202 initiates a resume procedure from a CAG identifier 1 (CAG ID-1). In step 3, the CAG-ID-1 is not in the allowed CAG list which is available with the gNB 204a. In step 4, the gNB 204a provides an RRC message (for example, a resume reject, or an RRC Connection release) to the UE 202 with a cause value. In step 5, with the received cause value, the UE 202 is expected to move to an RRC Idle mode (optionally) and initiate a Mobile Originated (MO) signalling (i.e., an Application Server (AS) indicates about the cause (or information) to the NAS and the NAS initiates the MO signalling towards the CN 206a. In step 6, when the NAS message (for example, the registration request) reaches the CN 206a, the CN 206a responds with another NAS message (for example, registration reject) which may carry the latest allowed CAG list.

In step 7, with the received latest allowed CAG list, the UE 202 receives the latest allowed CAG list, which is synchronized between the UE 202 and the CN 206a. Thus, the issue of asynchronization of allowed CAG list between the UE and the network may be resolved.

The cause value indicated in the step 4, is only for illustration purpose, basically the cause value is an indication to the UE 202 in a response RRC message or the NAS message. Thereby, the UE 202 may initiate the MO signalling towards the CN 206a (i.e., the RRC message may provide a fallback indication or the gNB 204a may execute the fallback procedure) to the UE 202.

The fallback indication may be propagated to the NAS. The NAS may trigger a NAS procedure (like registration procedure). For example, when the UE 202 in a 5GMM-CONNECTED mode with an RRC Inactive indication receives the fallback indication from the lower layers, and the UE 202 has no pending NAS procedure and no pending uplink user data for PDU session(s) with user-plane resources already established, the UE 202 may enter 5GMM-IDLE mode, initiate the registration procedure for mobility and periodic registration update and include a Uplink data status Information Element (IE) in a REGISTRATION REQUEST message indicating Protocol Data Unit (PDU) session(s) for which user-plane resources were active prior to receiving the fallback indication.

Further, when the gNB 204a identifies that the UE 202 is not in the allowed CAG list by checking its own database or by checking with source RAN node over the Xn interface (source RAN node may provide a reject cause “NPN access denied” or “CAG is not allowed”), then the gNB 204a performs the fallback procedure. As a response to the fallback procedure, the UE 202 may execute the NAS procedure like a registration procedure and so on.

In an embodiment herein, when the UE 202 receives the “CAG is not allowed” cause value, the UE 202 has to trigger the NAS procedure so that the UE 202 can get synchronized with the network.

The fallback procedure discussed is a procedure used in the existing specification, wherein the UE 202 sends a RRC RESUME message to the gNB 204a. In response to the RRC RESUME message, the gNB 204a sends the RRC Connection Setup message (i.e., the CN 206a and the UE 202 do not proceed with resume procedure rather switches to the RRC Connection setup procedure in the subsequent steps).

The embodiments disclosed herein can be implemented through at least one software program running on at least one hardware device and performing network management functions to control the elements. The elements shown in FIGS. 2a to 4 can be at least one of a hardware device, or a combination of hardware device and software module.

The embodiments disclosed herein describe methods and systems for managing handling UE Radio Capability (URC) information. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the disclosure may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

1. A method performed by a network node in a communication system, the method comprising:
determining mobility of a user equipment (UE) from a first public land mobile network (PLMN) to a second PLMN;
determining whether the first PLMN and the second PLMN belong to a same tracking area identity (TAI) list; and
in case that the first PLMN and the second PLMN belong to the same TAI list, indicating a URC identifier (URC-ID) of the second PLMN to a radio access network (RAN) associated with the second PLMN based on UE context information.

2. The method of claim 1, wherein the network node includes an access and mobility management function (AMF),
wherein the mobility of the UE from the first PLMN to the second PLMN is determined in case that the UE enters a connected mode on the second PLMN, and
wherein the UE context information includes the URC ID corresponding to a plurality of PLMNs belonging to the same TAI list.

3. The method of claim 1, wherein indicating the URC-ID of the second PLMN to the RAN comprises:
determining whether the URC-ID of the second PLMN is stored in the UE context information; and
in case that the URC-ID of the second PLMN is stored in the UE context information, indicating the URC-ID of the second PLMN to the RAN.

4. The method of claim 3, further comprising:
in case that the URC-ID of the second PLMN is not stored in the UE context information, assigning the URC-ID for the second PLMN;
storing the assigned URC-ID for the second PLMN in the UE context information; and
indicating the URC-ID of the second PLMN to the UE and the RAN associated with the second PLMN,
wherein the URC ID of the second PLMN is indicated to the UE (202) via a non-access stratum (NAS) message.

5. The method of claim 1, further comprising:
using at most one URC ID from the UE context information at any given time,
wherein the URC-ID is associated with a PLMN selected by the UE.

6. A method performed by a network node in a communication system, the method comprising:
receiving, from a user equipment (UE), a request to register with a first public land mobile network (PLMN) identifier (ID);
transmitting, to the UE, a registration accept message with a tracking area identity (TAI) list;
storing a URC identity ID (URC-ID) for the first PLMN ID in UE context information;
determining that the UE has moved from the first PLMN ID to a second PLMN ID belonging to the same TAI list;
determining whether the URC-ID for the second PLMN ID is stored in the UE context information; and
in case that the URC-ID for the second PLMN ID is stored in the UE context information, indicating the URC-ID for the second PLMN ID to a radio access network (RAN) associated with the second PLMN ID.

7. The method of claim 6, further comprising:
in case that the URC-ID for the second PLMN ID is not stored in the UE context information, assigning the URC-ID for the second PLMN ID;
storing the assigned URC-ID for the second PLMN ID in the UE context information; and
indicating the URC-ID of the second PLMN ID to the UE and the RAN associated with the second PLMN ID.

8. A network node in a communication system, the network node comprising:
a transceiver; and
a processor coupled with the transceiver and configured to:
determine a mobility of a user equipment (UE) from a first public land mobile network (PLMN) to a second PLMN,
determine whether the first PLMN and the second PLMN belong to a same tracking area identity (TAI) list, and
in case that the first PLMN and the second PLMN belong to the same TAI list, indicate a URC identifier (URC-ID) of the second PLMN to a radio access network (RAN) associated with the second PLMN based on UE context information.

9. The network node of claim 8, wherein the network node includes an access and mobility management function (AMF),
wherein the mobility of the UE from the first PLMN to the second PLMN is determined in case that the UE enters a connected mode on the second PLMN, and
wherein the UE context information includes the URC ID corresponding to a plurality of PLMNs belonging to the same TAI list.

10. The network node of claim 8, wherein the processor is configured to:
determine whether the URC-ID of the second PLMN is stored in the UE context information, and
in case that the URC-ID of the second PLMN is stored in the UE context information, indicate the URC-ID of the second PLMN to the RAN.

11. The network node of claim 10, wherein the processor is configured to:
in case that the URC-ID of the second PLMN is not stored in the UE context information, assign the URC-ID for the second PLMN,
store the assigned URC-ID for the second PLMN in the UE context information, and
indicate the URC-ID of the second PLMN to the UE and the RAN associated with the second PLMN,
wherein the URC ID of the second PLMN is indicated to the UE (202) via a non-access stratum (NAS) message.

12. The network node of claim 8, wherein the processor is further configured to:
use at most one URC ID from the UE context information at any given time,
wherein the URC-ID is associated with a PLMN selected by the UE.

13. A network node in a communication system, the network node comprising:
a transceiver; and
a processor coupled with the transceiver and configured to:
receive, from a user equipment (UE), a request to register with a first public land mobile network (PLMN) identifier (ID),
transmit, to the UE, a registration accept message with a tracking area identity (TAI) list,
store a URC identity ID (URC-ID) for the first PLMN ID in UE context information,
determine that the UE has moved from the first PLMN ID to a second PLMN ID belonging to the same TAI list,
determine whether the URC-ID for the second PLMN ID is stored in the UE context information, and
in case that the URC-ID for the second PLMN ID is stored in the UE context information, indicate the URC-ID for the second PLMN ID to a radio access network (RAN) associated with the second PLMN ID.

14. The network node of claim 13, wherein the processor is configured to:
in case that the URC-ID for the second PLMN ID is not stored in the UE context information, assign the URC-ID for the second PLMN ID, store the assigned URC-ID for the second PLMN ID in the UE context information, and
indicate the URC-ID of the second PLMN ID to the UE and the RAN associated with the second PLMN ID.
